(19) United States
(12) Patent Application Publication
(10) Pub. No.: US 2015/0354304 A1
(43) Pub. Date: Dec. 10, 2015

(54) METHOD AND APPARATUS FOR THERMALLY ACTUATING AND UNACTUATING DOWNHOLE TOOLS

(71) Applicants: Edward Wood, Kingwood, TX (US); David P. Gerrard, Montgomery, TX (US); Larry Watkins, Cypress, TX (US)

(72) Inventors: Edward Wood, Kingwood, TX (US); David P. Gerrard, Montgomery, TX (US); Larry Watkins, Cypress, TX (US)

(73) Assignee: Baker Hughes Incorporated, Houston, TX (US)

(21) Appl. No.: 14/630,076

(22) Filed: Feb. 24, 2015

Related U.S. Application Data
(60) Provisional application No. 62/010,106, filed on Jun. 10, 2014.

(51) Int. Cl. E21B 23/06; E21B 33/12; F03G 7/06

(52) U.S. Cl. CPC E21B 23/06; F03G 7/06; E21B 33/12

(57) ABSTRACT

A method for actuating a downhole tool comprising disposing a phase change material having selected volumetric change upon phase change in contact with a tool or tool component. Raising a temperature of the material above the phase change point of the material. Directing a resultant force of the volumetric increase of the phase change material to the tool or tool component.

### CROSS REFERENCE TO RELATED APPLICATION

This application claims the benefit of an earlier filing date from U.S. Provisional Application Ser. No. 62/010,106 filed Jun. 10, 2014 the entire disclosure of which is incorporated herein by reference.

### BACKGROUND

In the downhole industry, tools are often actuated and unactuated in the subsurface environment. These tools include packers, sleeves, etc. Setting/actuation methods and mechanisms include mechanical means, electrical means, hydraulic means, explosive means, etc. and all work for their intended purposes. It is however also the case that each has disadvantages as well. For example, while explosive means are commonly used, the overseas application of such devices is problematic in that the importation of explosives is strictly regulated. Mechanical and hydraulic means usually entail the need for a tubing string for conveyance. This may be impractical in deep or highly deviated wells. In electrical means, piezo devices are used but the stroke they produce is often insufficient for a particular actuation. In view of the foregoing, the industry continually welcomes new technologies that avoid prior drawbacks.

### SUMMARY

A method for actuating a downhole tool includes disposing a phase change material having selected volumetric change upon phase change in contact with a tool or tool component; raising a temperature of the material above the phase change point of the material; directing a resultant force of the volumetric increase of the phase change material to the tool or tool component.

A thermally actuated downhole tool includes a Phase Change Material (PCM) housing configured to contain a PCM in solid and liquid phases; a PCM disposed within the housing; a moveable component of the tool in operative communication with the PCM.

A packer including a mandrel; an element; and a PCM between the element and mandrel.

### BRIEF DESCRIPTION OF THE DRAWINGS

The following descriptions should not be considered limiting in any way. With reference to the accompanying drawings, like elements are numbered alike:

FIG. 1 is a schematic quarter section illustration of an apparatus for actuating and unactuating a packer in a run in position;

FIG. 2 is the embodiment of FIG. 1 in a set position;

FIG. 3 is the embodiment of FIG. 1 in a retracted position;

FIG. 4 is an alternate embodiment in a run in condition;

FIG. 5 is the embodiment of FIG. 4 in a ready for actuation condition;

FIG. 6 is the embodiment of FIG. 4 in an actuated condition;

FIG. 7 is the embodiment of FIG. 4 in an unactuated condition; and

FIG. 8 is a schematic illustration of an alternate embodiment.

### DETAILED DESCRIPTION

A method for actuating and unactuating downhole tools is effected by identifying and disposing a phase change material (PCM) that provides a relatively large volumetric change upon experiencing a phase change, “phase change” meaning a transition (in either direction) between Solid and Liquid or solid and gas or liquid and gas phases. In one example, a semi-crystalline polymeric materials exhibit an expansion in volume upon transitioning from a solid phase to a liquid phase of about 20%. The material is disposed in operative communication with a tool or tool component that requires movement. In some embodiments, the material will be placed in a condition where the increase in volume is entirely focused in one direction such as where the material is placed in a cavity within which a piston is cyclable but is sufficiently resistant to prevent volumetric growth of the material in a direction other than to urge the piston out of the cavity. The material is subjected to an increase in temperature to greater than its phase change temperature, thereby causing the material to liquefy. The liquefied material exerts a force upon the tool or tool component (for example the piston just mentioned) in which it is in contact and actuates the tool.

Materials that exhibit favorable expansion ratios include: Polyethylene (including as particular examples High Density Polyethylene; Ultra High Molecular Weight Polyethylene); and Polyphenylene Sulfide.

Effecting phase change may be accomplished in a number of distinct ways each of which results in the temperature of the PCM exceeding its phase change temperature or in combinations of ways. In a thermal well, cooling fluid is injected during completion of the well. By reducing cooling injection the thermal well will naturally increase in temperature resulting in the increase of the temperature of the environment of the phase change material to above its phase change point. In another iteration, the phase change may be effected during heated media injection in a well such as, for example, a SAGD (Steam Assisted Gravity Drainage) well. Yet still in another embodiment, the phase change material may be heated by a heating element disposed with or in close proximity to (close enough for the heat generated to raise the temperature of the phase change material to above its phase change temperature) the PCM. Combinations including at least one of the foregoing embodiments are also contemplated.

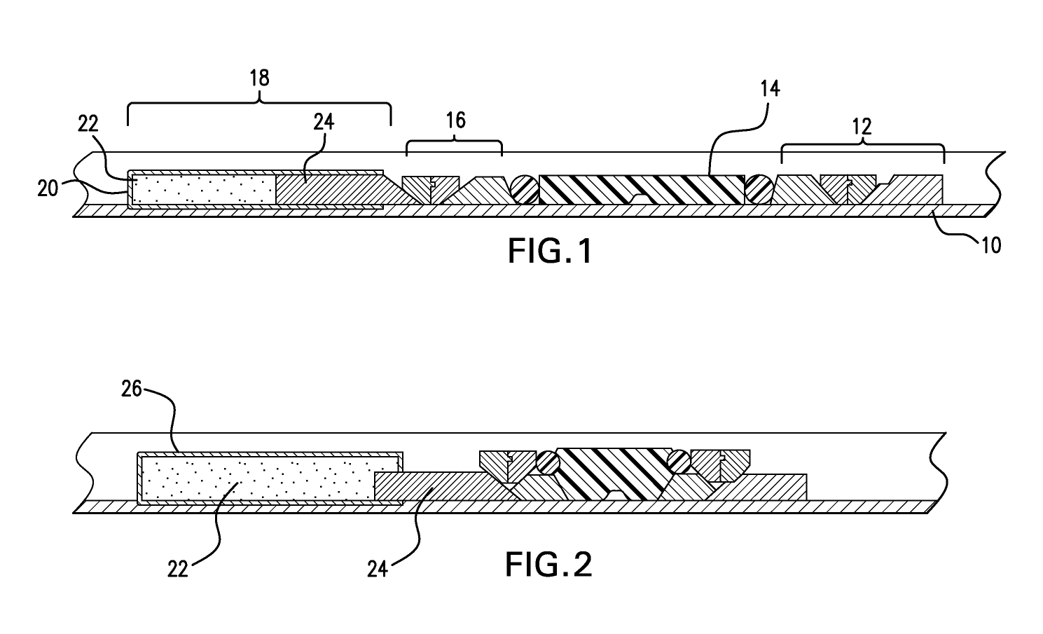

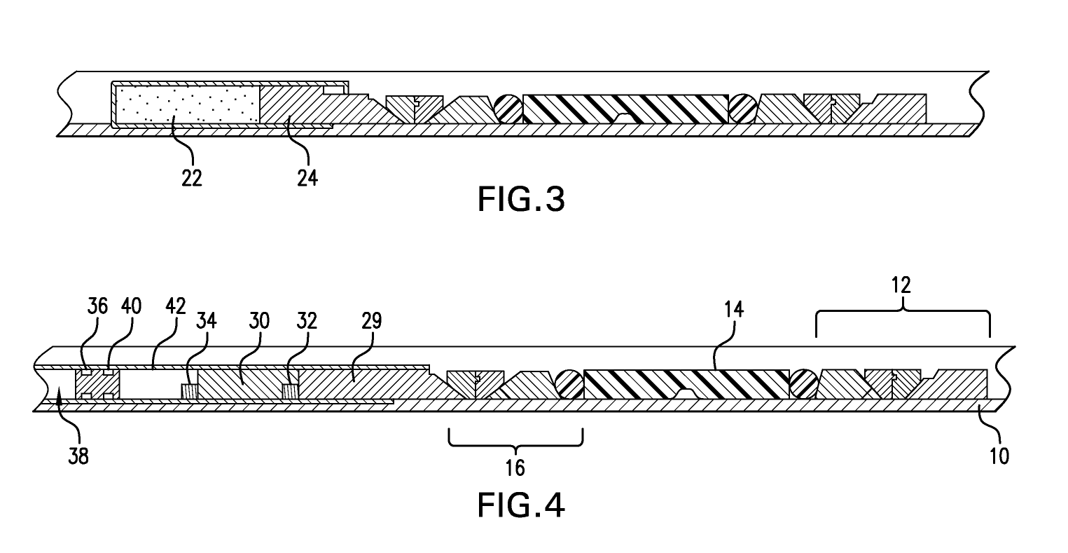

Referring to FIG. 1, a schematic quarter section illustration of one embodiment of a thermally actuated and/or unactuated tool using a PCM is provided. Tools include packers, plugs, sleeves, valves, etc. This embodiment is illustrated as a packer configured to be actuated and unactuated based upon the phase change of a PCM. The illustration is in a run in position and shows a mandrel 10; a set of slips 12 disposed on the mandrel 10; a packing element 14; another set of slips 16; and a PCM assembly 18. The PCM assembly includes a PCM housing 20 surrounding a PCM 22. The housing is configured to contain the PCM during solid and liquid phases. Further, in one embodiment, a movable component is illustrated as a piston 24 and is disposed in the housing 20. In this embodiment, there is a single piston shown but it is to be understood that a second piston operating in another direction is also contemplated. It is also to be understood that the PCM could be placed in contact with any moveable component that requires such movement for any operational action. For example, while a piston is shown in the figure, the piston could be eliminated and the PCM could directly contact the slip 16. Indeed, in one embodiment (see FIG. 8), the PCM 22 can be positioned directly radially inwardly of the element 14 such that upon phase change, the element will be expanded outwardly to contact a target surface. Upon increasing temperature of the PCM 22 above the phase change temperature the configuration will move to the position illustrated in FIG. 2. As one of skill in the art will recognize, the piston 24 has moved toward the slips and element causing those components to take on a set position. Upon the temperature falling to a level below the phase change point of the PCM, and assuming that the particular embodiment does not contain slips that permanently bite into a surface against which they set, then the retraction of the piston 24 will cause the other components of the tool to revert to the run in position, whereby retrieval of the tool is facilitated. Increasing the temperature of the PCM may occur in any of the processes noted above or may be effected by a heating element 26 (see FIG. 2) in thermally communicative position relative to the PCM.

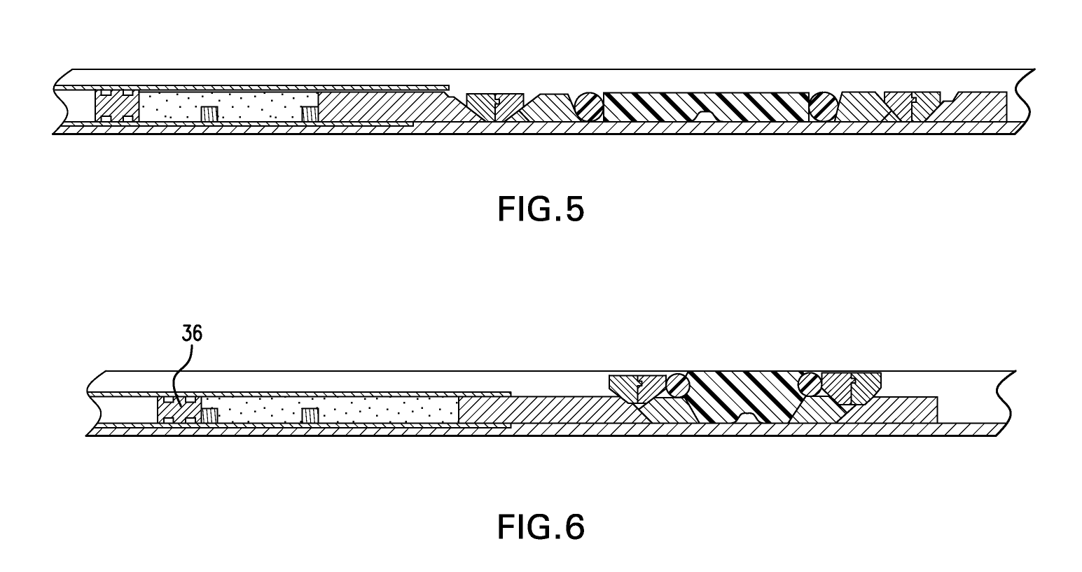

In another embodiment, the PCM is employed as a part of an actuation operation rather than to independently cause the actuation operation. More specifically, referring to FIG. 4, it will be appreciated that the components 10, 12, 14, 16 and 24 are essentially the same and are not redescribed but that the balance of the tool has changed. Directing attention to the left side of the drawing, the piston 24 is seen to be in contact with a PCM 30 similar to the foregoing embodiment but it is also in contact with a stop 32. The stop 32 will prevent the PCM 30 when in solid form from exerting any force on the piston 30 regardless of the position of a pressure piston 36. An additional stop 34 functions to maintain the solid phase PCM 30 in place at an end thereof opposite the piston 24 and functions to stop progress of the pressure piston 36 when that piston 36 is moved pursuant to pressure being applied thereto. Pressure piston 36 is responsive to tubing pressure or in some embodiments an alternate pressure source such as a control line, etc. In the illustrated embodiment, the source is tubing pressure applied through a port 38. Pressure piston 36 is configured in one embodiment with locking teeth 40 to engage complementary locking teeth 42 near stop 34. Hence once the pressure piston is stroked with increased pressure, it will stay locked in the position shown in FIG. 6. This is an important function to note. The pressure piston may be prestroked without actuating the tool (PCM in solid form)or may be used to actuate the tool (PCM in liquid form) depending upon whether or not the PCM 30 is in solid or liquid form at the time of stroking of the pressure piston 36. If stroking of the pressure piston 36 occurs while the PCM 30 is in solid form, the pressure piston 36 will pre condition the tool to be actuated by the PCM when the phase change occurs. Alternatively, if the phase change of the PCM 30 occurs prior to the stroking of the pressure piston 36 (i.e. the pressure piston is post stroked), the action of the pressure piston 36 stroking will cause actuation of the tool through the liquefied PCM. Referring to FIGS. 5 and 6 simultaneously, it will be appreciated that the PCM 30 has phase changed to a liquid form, expanded about 20% and is a hydraulic link between the pressure piston 36 and the piston 24. It will be noted that the stops 32 and 34, provide no obstacle to the system because the PCM is in liquid form. In FIG. 6, the pressure piston 36 has been stroked and actuated the tool.

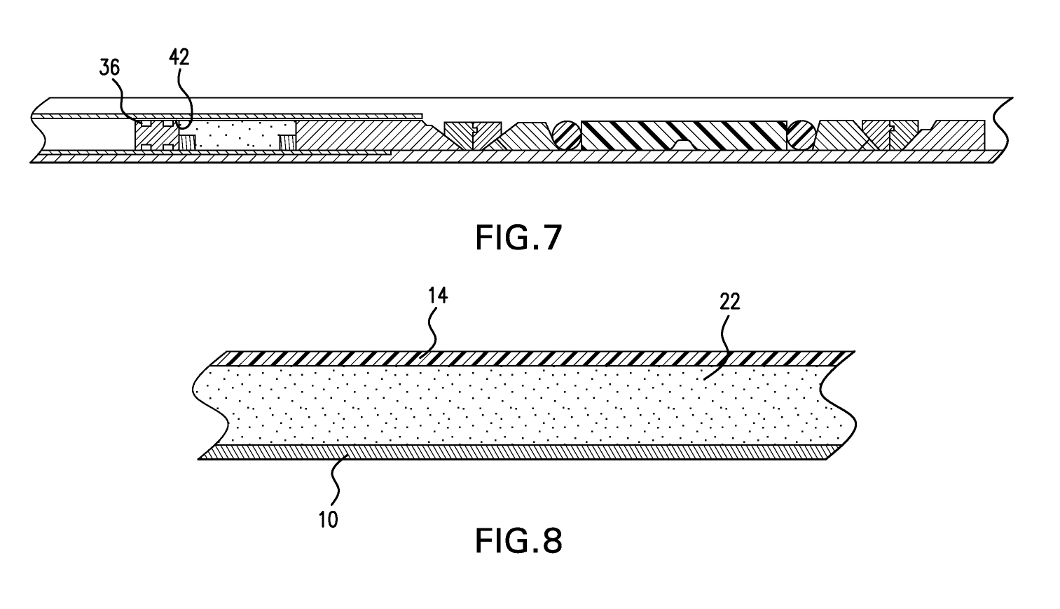

Referring to FIG. 7 it is to be understood that the tool may be unactuated even though the pressure piston 36 is permanently locked in place at teeth 42. This is due to the contraction that occurs when the PCM 30 reverts to a solid form upon being cooled below its phase change point. As illustrated, the PCM 30 has phase changed back to a solid thereby removing the 20% expansion in its volume that was keeping the tool actuated. Accordingly, the tool will be unactuated upon PCM 30 resolidifying.

It is to be understood that all of the thermal considerations and activity discussed above applies to this embodiment as well.

While the invention has been described with reference to an exemplary embodiment or embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the claims. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

1. A method for actuating a downhole tool comprising:
disposing a phase change material having selected volumetric change upon phase change in contact with a tool or tool component;
raising a temperature of the material above the phase change point of the material;
directing a resultant force of the volumetric increase of the phase change material to the tool or tool component.

2. The method as claimed in claim 1 wherein the raising is by allowing natural thermal environmental energy to act on the phase change material.

3. The method as claimed in claim 2 wherein the raising is by eliminating cooling actions performed on the environment of the phase change material.

4. The method as claimed in claim 1 wherein the raising is by a heating element.

5. The method as claimed in claim 1 wherein the raising is by applying heated medium to the environment of the phase change material.

6. The method as claimed in claim 1 wherein the phase change is liquefying.

7. The method as claimed in claim 1 further comprising unactuating the downhole tool.

8. The method as claimed in claim 7 wherein the unactuating comprises phase changing the phase change material from a liquid phase to a solid phase.

9. The method as claimed in claim 8 wherein the changing is by cooling the phase change material.

10. The method as claimed in claim 8 wherein the cooling is by applying cooling heated medium to the environment of the phase change material.

11. A thermally actuated downhole tool comprising:
a Phase Change Material (PCM) housing configured to contain a PCM in solid and liquid phases;
a PCM disposed within the housing;
a moveable component of the tool in operative communication with the PCM.

12. The tool as claimed in claim 11 wherein the PCM is a semi crystalline polymeric material.

13. The tool as claimed in claim 11 wherein the PCM is Polyethylene.

14. The tool as claimed in claim 11 wherein the moveable component is a piston.

15. The tool as claimed in claim 11 wherein the tool is a packer.

16. The tool as claimed in claim 11 further comprising a pressure piston in communication with the PCM.

17. The tool as claimed in claim 16 wherein the PCM is a hydraulic link between the moveable component and the pressure piston.

18. The tool as claimed in claim 16 wherein the pressure piston is prestrokable with the PCM in solid phase or post strokable with the PCM in liquid phase.

19. The tool as claimed in claim 16 wherein the tool is unactuatable by phase change of the PCM to solid phase.

20. A packer comprising:
a mandrel;
an element; and
a PCM between the element and mandrel.
